(19) United States
(12) Patent Application Publication
(10) Pub. No.: US 2015/0332166 A1
(43) Pub. Date: Nov. 19, 2015

(54) MACHINE LEARNING-BASED USER BEHAVIOR CHARACTERIZATION

(71) Applicant: INTEL CORPORATION, Santa Clara, CA (US)

(72) Inventors: RON FERENS, Ramat Hasharon (IL); GILA KAMHI, Zichron Yaakov (IL); AMIT MORAN, Tel Aviv (IL)

(21) Appl. No.: 14/127,995

(22) PCT Filed: Sep. 20, 2013
(86) PCT No.: PCT/US2013/060868

§ 371 Date: Dec. 20, 2013

(51) Int. Cl. G06N 99/00

(52) U.S. Cl. CPC G06N 99/005

(57) ABSTRACT

This disclosure is directed to machine learning-based user behavior characterization. An example system may comprise a device including a user interface module to present content to a user and to collect user data (e.g., including user biometric data) during the content presentation. The system may also comprise a machine learning module to determine parameters for use in presenting the content based on the user data. For example, the machine learning module may formulate a behavioral model including user states based on the user data, the user states being correlated to an objective (e.g., based on a cost function) and content presentation parameter settings. Employing the behavioral model, the machine learning module may determine a current user state based on the user data, and may select the content presentation parameter settings to bias movement of the current observed user state towards an observed user state associated with the maximized cost function.

### TECHNICAL FIELD

The present disclosure relates to presenting content on devices, and more particularly, to a system for configuring the presentation of content based on an analysis of user behavior.

### BACKGROUND

Emerging electronic devices are continuing to drive user demand for the delivery of on-demand content. For example, users may be able to access a variety of content utilizing a personal computer having access to a wireless area network (WAN) (e.g., the Internet), a mobile Internet-connected device (e.g., a smart phone), an Internet-enabled television (e.g., smart TV), etc. The content may be delivered by a variety of providers and may span a multitude of topics. For example, users may desire to hear/view entertainment content, play video games, etc. when waiting in line, traveling on public transportation or just relaxing at home. Students may be educated through content delivered to “electronic classrooms.” Businesspeople may conduct meetings, view lectures, etc. related to their professional pursuits. The presentation of content may also differ between providers (e.g., the quality at which content is presented may be variable, the content may include advertisements, etc.). A consequence of the increased availability of on-demand content is that content providers must maximize the quality of experience for users because it is now so easy for users to select alternative content if their interest begins to wane.

A traditional manner in which to maintain user interest is to design content based on a demographic of consumers. For example, by targeting content for the largest demographic of expected consumers, a content provider can expect to get “the most bang for the buck.” This strategy has been employed for many years by content providers such as TV/movie studios, game providers, etc. However, the success of such a strategy relies somewhat on there being only a limited number of alternative offerings available to the content consumer. A problem presented by the new age of on-demand content delivery is that there are a great number of alternative content options available to content consumers at any given time, and so striving for what may appeal to the greatest demographic of users may not be sufficient to lock user attention. The presentation of content must both attract and hold the attention of the user during the brief period of time at the commencement of the presentation of the content.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for machine learning-based user behavior characterization in accordance with at least one embodiment of the present disclosure;

FIG. 2 illustrates an example configuration for a device usable in accordance with at least one embodiment of the present disclosure:

FIG. 3 illustrates example user data and content parameters in accordance with at least one embodiment of the present disclosure;

FIG. 4 illustrates an example chart of a cost function, changeable parameters and user data collection in accordance with at least one embodiment of the present disclosure;

FIG. 5 illustrates an example of user state determination based on user data in accordance with at least one embodiment of the present disclosure;

FIG. 6 illustrates an example of correlating user state, cost function and changeable parameters in accordance with at least one embodiment of the present disclosure;

FIG. 7 illustrates an example behavioral model in accordance with at least one embodiment of the present disclosure; and

FIG. 8 illustrates example operations for machine learning-based user behavior characterization in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to machine learning-based user behavior characterization. A system may comprise, for example, a device including a user interface module to present content to a user and to collect user data (e.g., possibly including user biometric data) during the presentation of the content. The system may further comprise a machine learning module that may be situated in the presentation device or another device (e.g., at least one computing device accessible via a WAN like the Internet). The machine learning module may determine parameters for use in presenting the content based on the collected user data. For example, the machine learning module may formulate a behavioral model including user states based on the user data, the user states being correlated to an objective (e.g., in the form of a cost function) and content presentation parameter settings. Employing the behavioral model, the machine learning module may determine a current user state based on the user data, and may select the content presentation parameter settings to bias movement of the current observed user state towards an observed user state associated with the maximized cost function.

In one embodiment, a system may comprise, for example, a device and a machine learning module. The device may include at least a user interface module to present content to a user and to collect data related to the user during the presentation of the content. The machine learning module may be to generate a user behavioral model including at least observed user states and determine a correspondence between the observed user states and at least one objective using the behavioral model and content presentation parameters. The machine learning module may also be to utilize the behavioral model to determine a current observed user state based on the user data and utilize the behavioral model to determine content presentation parameter settings based at least on the current observed user state.

The behavioral model may be generated based on user data collected during the presentation of the content with randomized content presentation parameter settings. In one embodiment, the device may further comprise a sensor module to collect biometric data from the user during the presentation of the content, the user data including at least the biometric data. The machine learning module may further be to input the biometric data to the behavioral model to determine the current observed user state. The at least one objective may be defined in the behavioral model based on a cost function, the at least one objective being to maximize the cost function. The correspondence may comprise associating each observed user state with a value for the cost function. In addition, the correspondence may further comprise associating content presentation parameter settings for biasing movement between the observed user states. The machine learning module being to determine content presentation parameter settings may comprise the machine learning module being to select the content presentation parameter settings to bias movement of the current observed user state towards an observed user state associated with the maximized cost function.

In the same or a different embodiment, the device may further comprise an application to receive the content presentation parameter settings from the machine learning module and determine content presentation parameter updates for causing the user interface module to alter the presentation of the content based on the content presentation parameter settings. The machine learning module may be situated in at least one remotely located computing device accessible to the device via a wide area network. An example method consistent with the present disclosure may comprise generating a user behavioral model including at least observed user states, determining a correspondence between the observed user states and at least one objective using the behavioral model and content presentation parameters, collecting user data, utilizing the behavioral model to determine a current observed user state based on the user data, utilizing the behavioral model to determine content presentation parameter settings based at least on the current observed user state and causing the content to be presented based on the content presentation parameter settings.

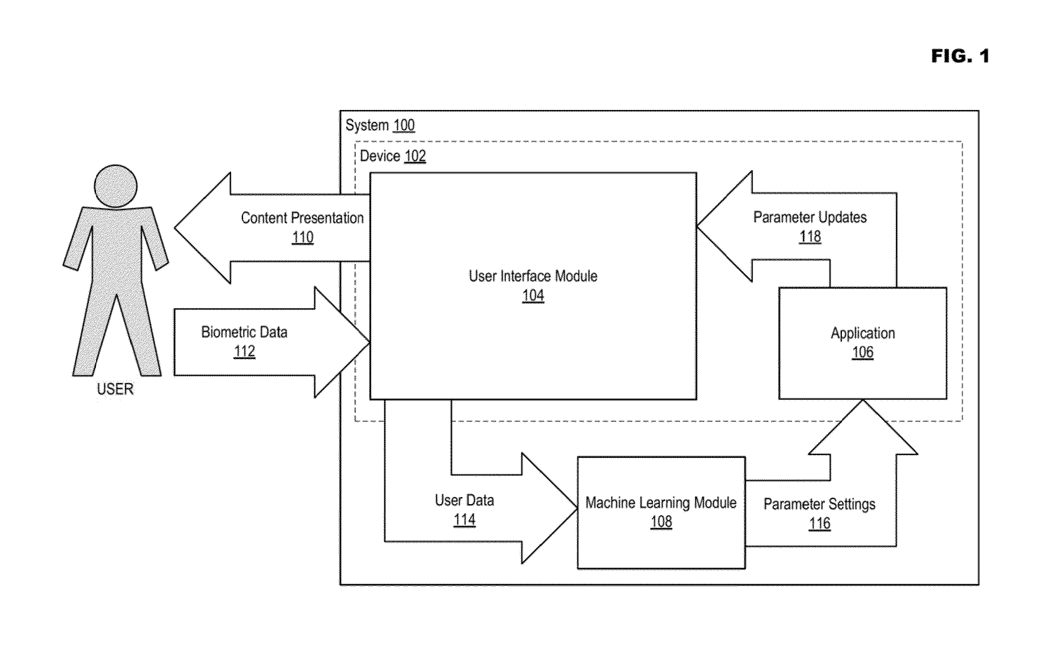

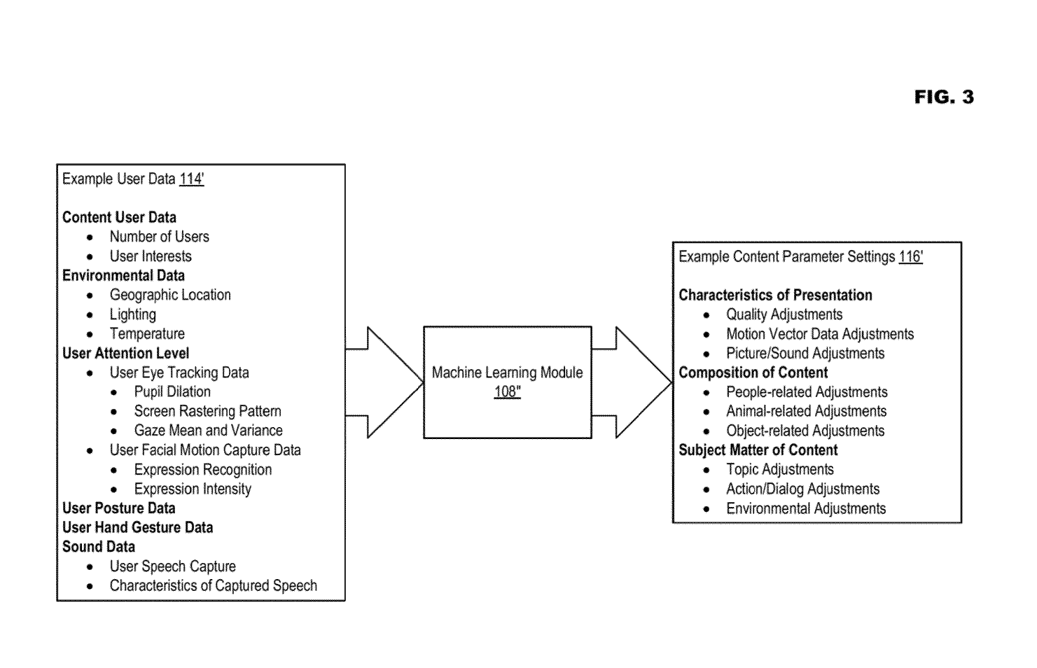

FIG. 1 illustrates an example system for machine learning-based user behavior characterization in accordance with at least one embodiment of the present disclosure. System 100 may comprise, for example, at least one device 102. Examples of device 102 may comprise, but are not limited to, a mobile communication device such as a cellular handset or a smartphone based on the Android® operating system (OS), iOS®, Windows® OS, Blackberry® OS, Palm® OS, Symbian® OS, etc., a mobile computing device such as a tablet computer like an iPad®, Surface®, Galaxy Tab®. Kindle Fire@, etc., an Ultrabooxk® including a low-power chipset manufactured by Intel Corporation, a netbook, a notebook, a laptop, a palmtop, etc., a stationary computing device such as a desktop computer, a set-top device, a smart television (TV), etc. Device 102 may comprise, for example, at least user interface module 104 and application 106. User interface module 104 may be configured to present content to a user as shown at 110 and to collect user data 114. Content may include various multimedia information (e.g., text, audio, video and/or tactile information) such as, but not limited to, music, movies, short programs (e.g., TV shows, video made for Internet distribution, etc.), instructional lectures/lessons, video games, applications, advertisements, etc. User data 114 may include information about users collected during content presentation 110 (e.g., including biometric data 112, examples of which are discussed further in FIG. 3). Application 106 may comprise software configured to cause user interface module 104 to at least present the content as shown at 110. Examples of application 106 may include audio and/or video players for presenting stored or streamed content, web browsers, video games, educational software, collaboration software (e.g., audio/video conferencing software), etc.

System 100 may further comprise machine learning module 108. In one embodiment machine learning module may be incorporated within device 102. Alternatively, some or all of machine learning module 108 may be distributed between various devices. For example, some or all of the functionality performed by machine learning module 108 may be handled by a remote resource such as, for example, at least one computing device (e.g., a server) that is accessible via a WAN like the Internet in a “cloud” computing-type architecture. Device 102 may then interact with the remote resource via wired and/or wireless communication. A distributed architecture may be employed in situations wherein, for example, device 102 may not include resources sufficient to perform the functionality associated with machine learning module 108. In one embodiment, machine learning module 108 may comprise a behavioral model into which user data 114 may be input. User data 114 may comprise biometric data 112 but may also include other data pertaining to the user such as demographic data, interest data, etc. Machine learning module 108 may employ user data 114 in determining parameter settings 116. For example, as will be disclosed further in FIG. 3-8, machine learning module 108 may determine a current user state corresponding to the user based on user data 114 and may then determine parameter settings 116 that may cause the current user state to transition towards a desired user state (e.g., corresponding to an objective defined by a cost function).

Machine learning module 108 may then provide parameter settings 116 to application 106 in device 102. Application 106 may use parameter settings 116 in determining parameter updates 118. Parameter updates 118 may include, for example, changes that may be made to content presentation 110 based on the current user state and the user state objective needed to satisfy the cost function. Parameter updates 118 may then cause user interface module 104 to alter content presentation 110. User interface module 104 may then reinitiate operations by collecting user data 114 (e.g., including biometric data 112) to determine current user state.

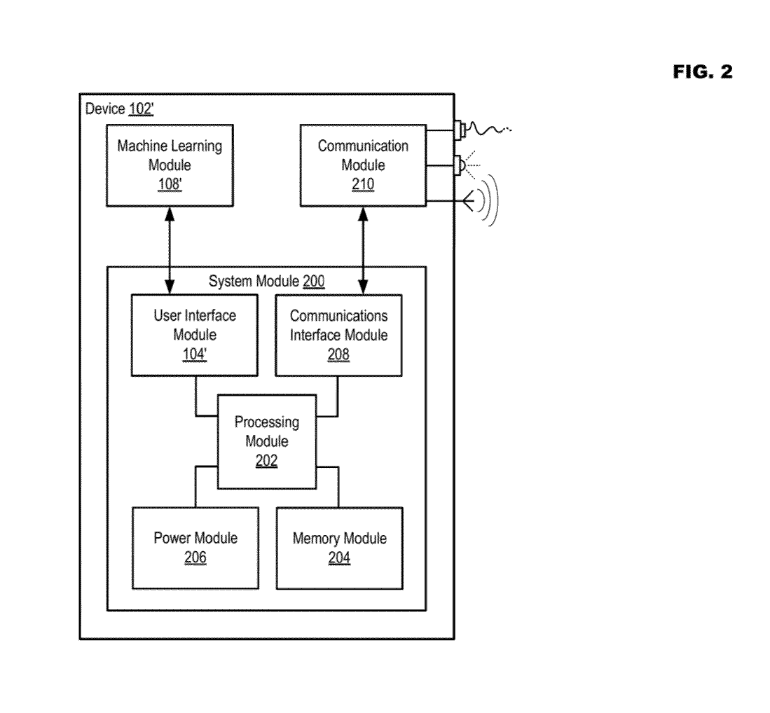

FIG. 2 illustrates an example configuration for a device usable in accordance with at least one embodiment of the present disclosure. In particular, while device 102′ may perform example functionality such as disclosed in FIG. 1, device 102′ is meant only as an example of equipment usable in accordance with embodiments consistent with the present disclosure, and is not meant to limit these various embodiments to any particular manner of implementation. For example, as previously set forth, machine learning module 108 may reside in a separate device, such as in a cloud-based resource including at least one computing device accessible via a WAN like the Internet.

Device 102′ may comprise system module 200 to manage device operations. System module 200 may include, for example, processing module 202, memory module 204, power module 206, user interface module 104′ and communications interface module 208. Device 102′ may also comprise machine learning module 108′ to interact with at least user interface module 104′ and communication module 210 to interact with at least communications interface module 208. While machine learning module 108′ and communication module 210 are shown separately from system module 200, this arrangement is merely for the sake of explanation herein. Some or all of the functionality associated with machine-learning module 108′ and/or communication module 210 may also be incorporated within system module 200).

In device 102′, processing module 202 may comprise one or more processors situated in separate components, or alternatively, one or more processing cores embodied in a single component (e.g., in a System-on-a-Chip (SaC) configuration) along with processor-related support circuitry (e.g., bridging interfaces, etc.). Example processors may include, but are not limited to, various x86-based microprocessors available from the Intel Corporation including those in the Pentium, Xeon, Itanium, Celeron. Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102′. Some or all of the functionality commonly associated with the support circuitry may also be included in the same physical package as a microprocessor (e.g., in an SoC package like the Sandy Bridge integrated circuit available from the Intel Corporation).

Processing module 202 may be configured to execute various instructions in device 102′. Instructions may include program code configured to cause processing module 202 to perform activities related to reading data, writing data, processing data, formulating data, converting data, transformnning data, etc. Information (e.g., instructions, data, etc.) may be stored in memory module 204. Memory module 204 may comprise random access memory (RAM) and/or read-only memory (ROM) in a fixed or removable format. RAM may include memory configured to hold information during the operation of device 102′ such as, for example, static RAM (SRAM) or Dynamic RAM (DRAM). ROM may include memories such as bios memory configured to provide instructions when device 102′ activates in the form of bios, Unified Extensible Firmware Interface (UEFI), etc., programmable memories such as electronic programmable ROMs (EPROMS). Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD). USB, etc.), optical memories such as compact disc-based ROM (CD-ROM), etc. Power module 206 may include internal power sources (e.g., a battery) and/or external power sources (e.g., electromechanical or solar generator, power grid, fuel cell, etc.), and related circuitry configured to supply device 102′ with the power needed to operate.

User interface module 104′ may include circuitry configured to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 208 may be configured to handle packet routing and other control functions for communication module 210, which may include resources configured to support wired and/or wireless communications. Wired communications may include serial and parallel wired mediums such as, for example, Ethernet. Universal Serial Bus (USB), Firewire, Digital Visual Interface (DVI), High-Definition Multimedia Interface (HDMI), etc. Wireless communications may include, for example, close-proximity wireless mediums (e.g., radio frequency (RE) such as based on the Near Field Communications (NFC) standard, infrared (IR), optical character recognition (OCR), magnetic character sensing, etc.), short-range wireless mediums (e.g., Bluetooth, wireless local area networking (WLAN). Wi-Fi, etc.) and long range wireless mediums (e.g., cellular wide area radio communication technology, satellite technology, etc.). In one embodiment, communication interface module 208 may be configured to prevent wireless communications that are active in communication module 210 from interfering with each other. In performing this function, communication interface module 208 may schedule activities for communication module 210 based on, for example, the relative priority of messages awaiting transmission.

In the embodiment illustrated in FIG. 2, machine learning module 108′ may interact with at least user interface module 104′. For example, machine learning module 108′ may receive at least biometric data 112 from user interface module 104′. Biometric data 112 may be included in user data 114, which machine learning module 108′ may utilize when determining parameter settings 116. Moreover, machine learning module 108′ may also provide parameter settings 116 to user interface module 104′ (e.g., via application 106) for use in determining parameter updates 118 that may be used to alter content presentation 110.

FIG. 3 illustrates example user data and content parameters in accordance with at least one embodiment of the present disclosure. While FIG. 3 discloses a variety of data types and parameters consistent with embodiments of the present disclosure, the examples presented in FIG. 3 are merely for the sake of explanation herein and are not intended to be exclusive or limiting. Example user data 114′ may comprise user-related data and biometric data 112. Example user-related data may include a number of users partaking in content presentation 110, the interests of the content users, data about the environment surrounding the users (e.g., geographic location, lighting, temperature, etc.), etc. Biometric data 112 may include, for example, user attention level data, user posture data, user hand gesture data, sound data, etc. Example data for sensing user attention level may include user eye tracking data (e.g., pupil dilation, screen rastering pattern, gaze mean and variance, etc.) and user facial motion capture data, possibly including facial expression recognition and expression intensity determination. All of the above biometrics data 114′ may be sensed with an image capture component (e.g., a camera) incorporated in, or at least coupled to, user interface module 104. Sound data may include, for example, user speech capture that may be processed to determine characteristics for the captured speech. Sound data may be sensed utilizing a sound capture device (e.g. a microphone) incorporated in, or at least coupled to, user interface module 104.

Upon analyzing user data 114′ (e.g., using a behavioral model), machine learning module 108″ may determine example content parameters settings 116′. In general, these settings may control the characteristics of content presentation 110. Example content parameter settings 116′ may include characteristics of presentation, composition of content, subject matter of content, etc. Example characteristics of presentation may include quality adjustments (e.g., resolution, data caching for streaming, etc.), motion vector data adjustments, picture and sound adjustments (e.g., picture color depth, brightness, volume, bass/treble balance, etc.), etc. Example composition of content may include people-related adjustments (e.g., number, gender, age, ethnicity, etc.), animal-related adjustments (e.g., number of animals, types of animals, etc.), object related adjustments (e.g., higher or lower density of objects being presented, the types of objects, colors of objects, etc.), etc. Example subject matter of content may include topic adjustments (e.g., news, drama, comedy, sports, etc.), action/dialog adjustments to increase/decrease the amount of action and/or dialog in content presentation 110, environmental adjustments (e.g., the amount of light in the content, the weather in the content, the amount of background noise/activity in the content, etc.), etc.

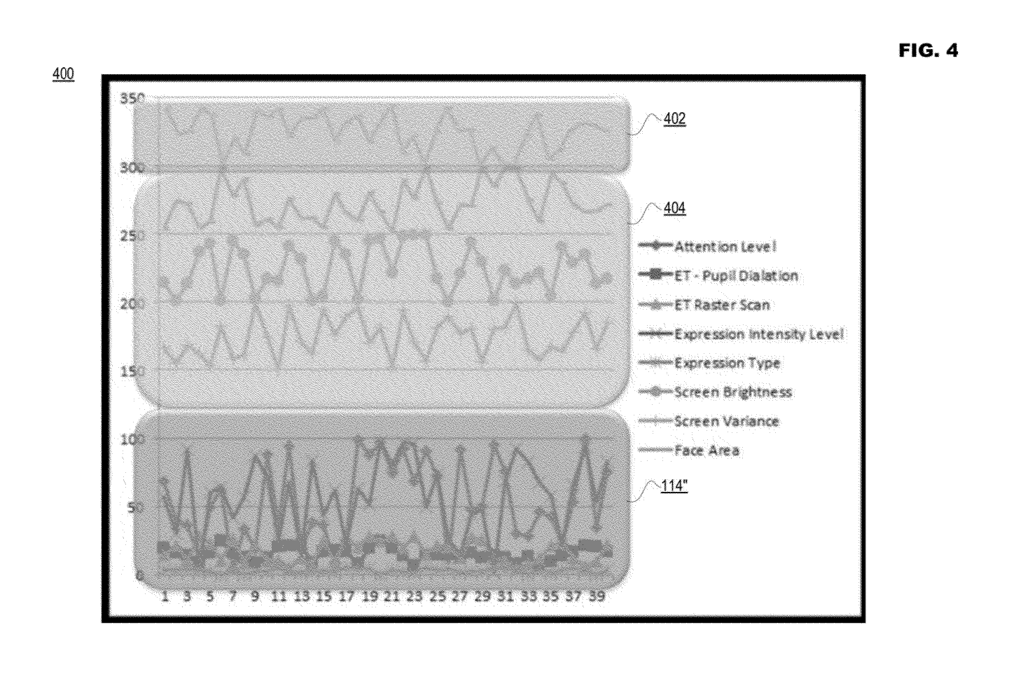

FIG. 4 illustrates an example chart of a cost function, changeable parameters and user data collection in accordance with at least one embodiment of the present disclosure. Chart 400 plots cost function 402 against a plot of current content presentation parameters 404 and a plot of user data 114″ over a certain period of time. In one embodiment, cost function 402 may comprise at least one measurable quantity corresponding to an objective desired to be maximized during content presentation 110. Examples of cost functions 402 may include user listening/viewing/playing time, user focus, the time a user remains in a certain state (e.g., happy, excited, etc.) during content presentation 110, etc. The plot of content presentation parameters 404 in FIG. 4 comprises screen brightness, screen variance and face area (e.g., facial focus on the content based on facial capture). The plot of user data 114″ in FIG. 4 comprises attention level, pupil dilation, raster scan, expression intensity level and expression type. The example relationships disclosed in FIG. 4 may be used to formulate a behavioral model based on the effect of content presentation 110, having certain parameters 404, on the user, as demonstrated by user data 114″, and how the effect manifests in cost function 402.

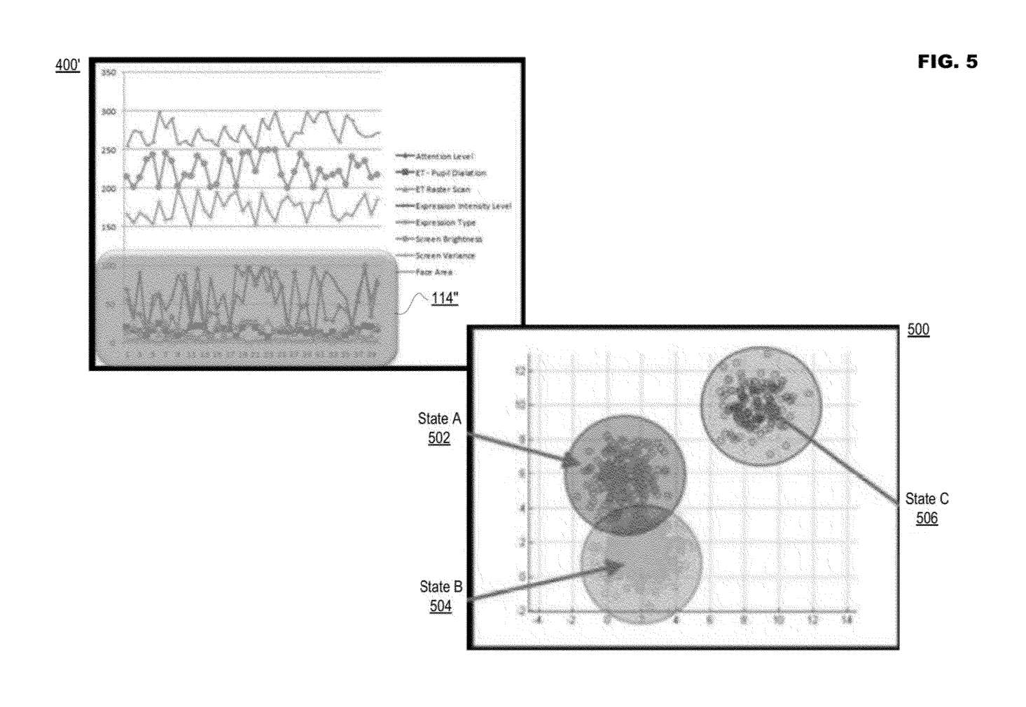

FIG. 5 illustrates an example of user state determination based on user data in accordance with at least one embodiment of the present disclosure. In one embodiment, the determination of user states may be an initial step in formulating a behavioral model. Chart 400″ comprises example user data 114″. Example user data 114″ may be analyzed as shown in chart 500 to determine various user states. User states may include, for example, different emotional states of a user as defined by groupings of particular conditions in user data 114″. For example, certain values of pupil dilation, expression type and intensity level, etc. may be grouped to characterize different user states. Example emotions that may correspond to user states include, but are not limited to, happy, excited, angry, bored, attentive, disinterested, etc.

The number of user states in the behavioral module may depend on, for example, the type of content presented, the ability to collect user data 114″, etc. Three example states are disclosed in FIG. 5. For example, state A 502 may correspond to a desired state, while state B 504 and state C 506 may correspond to less desirable user states. State A 502 may include a combination of long facial capture duration, desired expression and/or eye focus times with good pupillary response that indicate user attention or excitement. State B 504 may include user data 114″ indicating reduced interest in content presentation 110, while state C 506 may include user data 114″ that may reflect user dislike or aversion to content presentation 110.

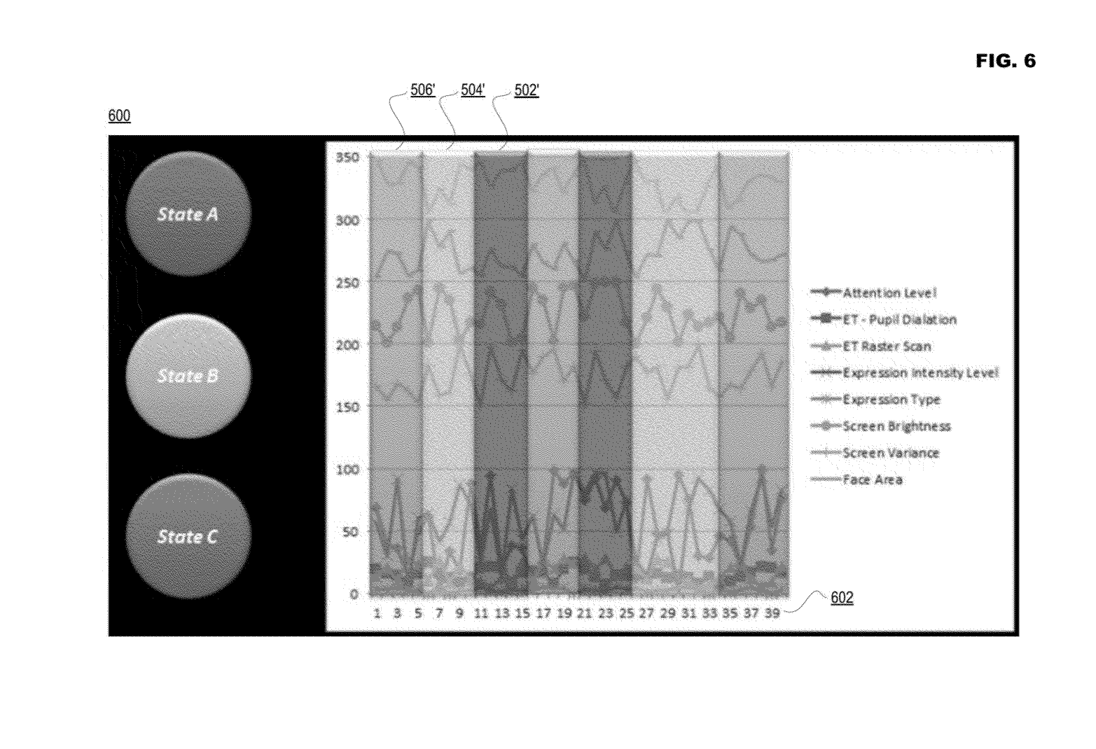

FIG. 6 illustrates an example of correlating user state, cost function and changeable parameters in accordance with at least one embodiment of the present disclosure. In FIG. 6, certain quantities from cost function 402, current content parameters 404 and user data 114″ may be correlated to user states at different times 602. For example, user data 114″ set forth in chart 600 between times 1 and 5 may correlate to user state C 506′. Whenever values are collected for user data 114″ that fall within the range of values set forth in this region, the user may be determined to be in user state C 506′. Similarly, the region between 5 and 9 may include data values corresponding to user state B 504′ and the region between 11 and 15 may correspond to user state A 502′. Moreover, the values for cost function 402 may also be correlated to the user state to determine, for example, the effect on cost function 402 (e.g., the effect on the objective to be achieved) when the user is in a particular state. Current content parameters 406 may also be correlated to determine how changing content parameter settings 116 bias changes in user state towards a desired state, and thus, help to achieve the objective.

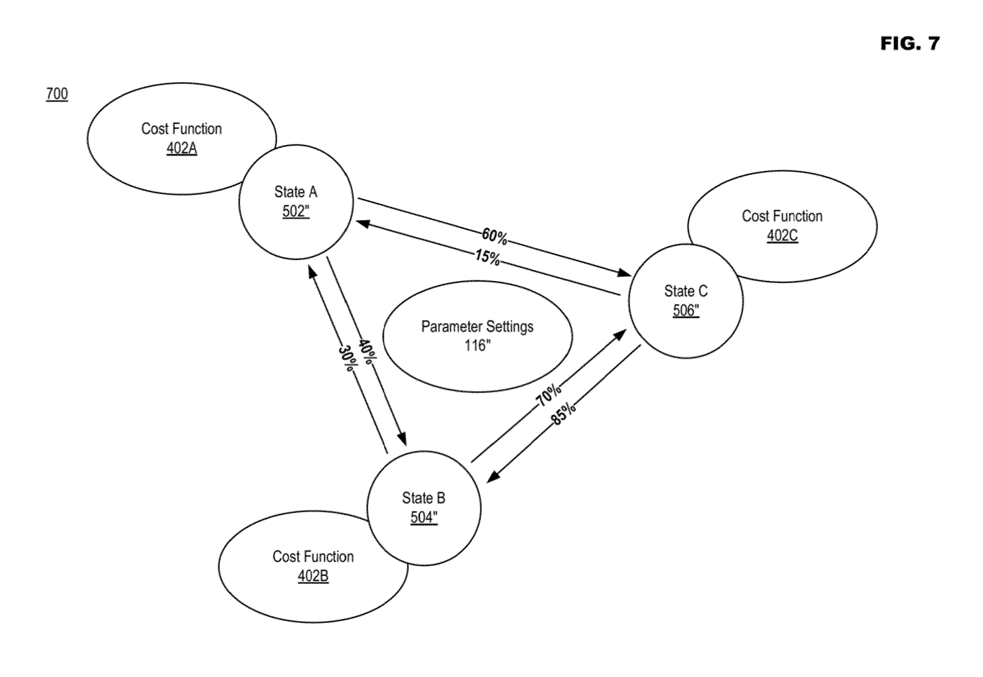

FIG. 7 illustrates an example behavioral model in accordance with at least one embodiment of the present disclosure. Behavioral model 700 represents interrelationships between user states 502″, 504″ and 506″, parameter settings 116″ that may cause a user to move from one user state to another, and how each user state satisfies cost function 402 (e.g., the objective sought by the content author, provider, etc.). For example, state A 502″ may correspond to a desired user state in that state A 502″ may cause cost function 402 A to be maximized (e.g., the user is totally focused on content presentation 110). State B 504″ may correspond to a middle state wherein the result of cost function 402B may be somewhat lower than state A 502″(e.g., the user is somewhat focused on content presentation 110). State C 506″ may correspond to a user state wherein cost function 402C is substantially lower than state A 502″(e.g., the user is totally disinterested in content presentation 110).

Parameter settings 116″ may bias transitions between user states. For example, the behavioral model may predict that given a user is determined to be in state B 504″ there may be a 30% probability that parameter settings 116″ will cause the user to transition from user state B 504″ to user state A 502″ and a 70% probability that the user will transition from state B 504″ to user state C 506″. Likewise, given parameter settings 116″ there is an 85% probability for the user to transition from user state C 506″ to user state B 504″ and a 15% probability to transition from user state C 506″ to user state A 502″. When in user state A 502″ there may be a 40% probability to transition to user state B 504″ and a 60% probability to transition to user state C 506″. Given example parameter settings 116″ in FIG. 7, the probabilities in model 700 indicate that it will be more difficult to transition to user state A 502″(e.g., the desired state to achieve maximized cost function 402A) from user state B 504″ or user C 506″ than to remain in the less desirable states, and thus, that new parameter settings 116″ may be required. It is important to realize that the percentage probabilities provided in FIG. 7 are for the sake of explanation only, and may be determined empirically during a process by which model 700 is taught the interrelationships between the user states and parameter settings 116″. For example, initial learning for the model may be performed by content presentation 110 to a user based on various (e.g., randomized) parameter settings. As parameter settings 116″ are changed, model 700 may learn the how various parameter settings 116″ are related to user states 502″, 504″ and 506″, and how each of user states 502″. 504″ and 506′ satisfies cost function 402.

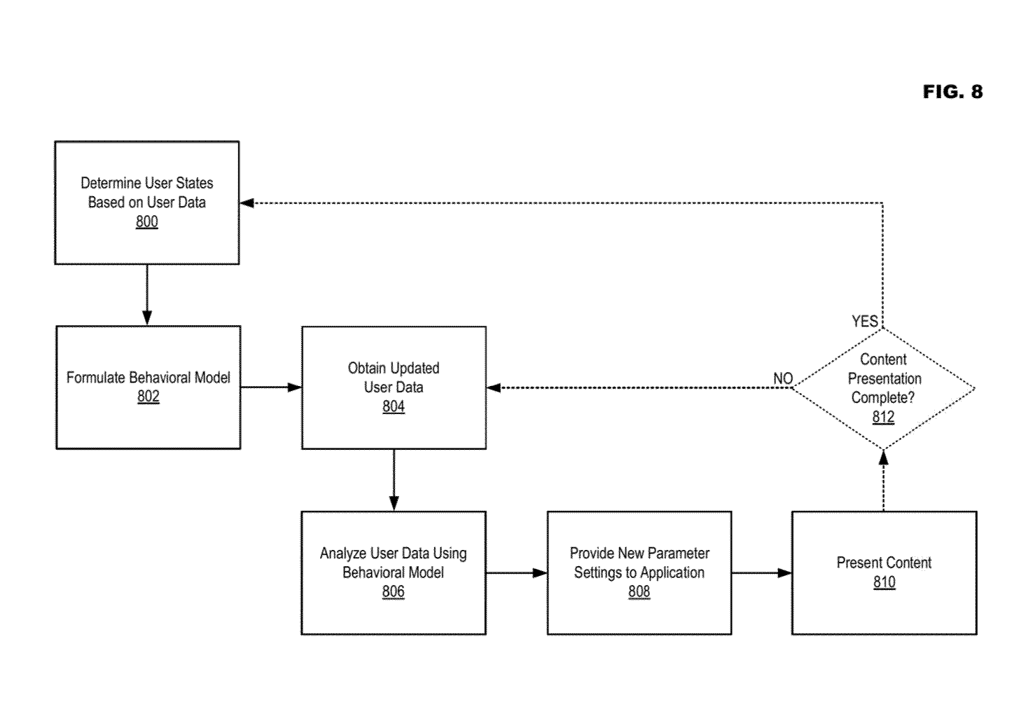

FIG. 8 illustrates example operations for machine learning-based user behavior characterization in accordance with at least one embodiment of the present disclosure. In operation 800 user states may be determined based on user data (e.g., including biometric data). For example, user data may be collected (e.g., by a user interface module in a device that presents content) and groupings or trends in the user data may be used to determine user states (e.g., by a machine learning module). A behavioral model may then be formulated in operation 802. For example, the user states may be correlated to an objective (e.g., defined based on a cost function) wherein at least one user state may be determined to achieve the objective (e.g., to maximize the cost function), and probabilities for biasing user transitions between the various user states may be determined based on content parameter settings (e.g., through a learning algorithm that determines how content parameters affect user state).

In operation 804 updated user data may be obtained. The updated user data may be analyzed utilizing the behavioral model in operation 806. For example, the updated user data may be used to determine a current user state. If the current user state does not achieve the objective of the behavioral model, then parameter settings may be selected to bias transition of the current user state to the user states that achieves the objective based on probabilities set forth in the behavioral model. In operation 808, the new parameter settings may be provided to an application. For example, the application may determine parameter updates based on the parameter settings. In operation 810, the application may then, for example, cause a user interface module in a device to present content based on the parameter updates. Optionally, in operation 812 a determination may be made as to whether the content presentation is complete. If it is determined in operation 812 that the content presentation is not complete, then in operation 804 updated user data may be collected. If it is determine in operation 812 that the content presentation is complete, then operation 812 may be followed by a return to operation 800 to prepare to determine new user states (e.g., for a new content presentation).

While FIG. 8 illustrates operations according to an embodiment, it is to be understood that not all of the operations depicted in FIG. 8 are necessary for other embodiments. Indeed, it is fully contemplated herein that in other embodiments of the present disclosure, the operations depicted in FIG. 8, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A. B and C. As used in this application and in the claims, a list of items joined by the term “at least one of” can mean any combination of the listed terms. For example, the phrases “at least one of A, B or C” can mean A; B; C; A and B; A and C; B and C; or A. B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories. Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to machine learning-based user behavior characterization. An example system may comprise a device including a user interface module to present content to a user and to collect user data (e.g., including user biometric data) during the content presentation. The system may also comprise a machine learning module to determine parameters for use in presenting the content based on the user data. For example, the machine learning module may formulate a behavioral model including user states based on the user data, the user states being correlated to an objective (e.g., based on a cost function) and content presentation parameter settings. Employing the behavioral model, the machine learning module may determine a current user state based on the user data, and may select the content presentation parameter settings to bias movement of the current observed user state towards an observed user state associated with the maximized cost function.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for machine learning-based user behavior characterization, as provided below.

### Example 1

According to this example there is provided a system. The system may comprise a device including at least a user interface module to present content to a user and to collect data related to the user during the presentation of the content and a machine learning module to generate a user behavioral model including at least observed user states, determine a correspondence between the observed user states and at least one objective using the behavioral model and content presentation parameters, utilize the behavioral model to determine a current observed user state based on the user data and utilize the behavioral model to determine content presentation parameter settings based at least on the current observed user state.

### Example 2

This example includes the elements of example 1, wherein the behavioral model is generated based on user data collected during the presentation of the content with randomized content presentation parameter settings.

### Example 3

This example includes the elements of example 2, wherein the observed user states in the behavioral model are determined based on determining concentrations of values in the user data collected during the presentation of the content with randomized content presentation parameter settings.

### Example 4

This example includes the elements of any of examples 1 to 3, wherein the device further comprises a sensor module to collect biometric data from the user during the presentation of the content, the user data including at least the biometric data.

### Example 5

This example includes the elements of example 4, wherein the biometric data is related to at least one of user attention level, user posture, user hand gestures, or sounds generated by the user.

### Example 6

This example includes the elements of any of examples 4 to 5, wherein the machine learning module is further to input the biometric data to the behavioral model to determine the current observed user state.

### Example 7

This example includes the elements of any of examples 1 to 6, wherein the at least one objective is defined in the behavioral model based on a cost function, the at least one objective being to maximize the cost function.

### Example 8

This example includes the elements of example 7, wherein the correspondence comprises associating each observed user state with a value for the cost function.

### Example 9

This example includes the elements of example 8, wherein one of the observed user states is associated with the maximized value of the cost function.

### Example 10

This example includes the elements of example 9, wherein the correspondence further comprises associating content presentation parameter settings for biasing movement between the observed user states.

### Example 11

This example includes the elements of example 10, wherein the biasing is based on percentage probabilities associated with transitioning between each of the observed user states when certain content presentation parameter settings are utilized for content presentation.

### Example 12

This example includes the elements of any of examples 10 to 11, wherein the machine learning module being to determine content presentation parameter settings comprises the machine learning module being to select the content presentation parameter settings to bias movement of the current observed user state towards the observed user state associated with the maximized cost function.

### Example 13

This example includes the elements of any of examples 1 to 12, wherein the device further comprises an application to receive the content presentation parameter settings from the machine learning module and determine content presentation parameter updates for causing the user interface module to alter the presentation of the content based on the content presentation parameter settings.

### Example 14

This example includes the elements of any of examples 1 to 13, wherein the content parameters settings control at least one of content presentation characteristics, content composition or content subject matter.

### Example 15

This example includes the elements of any of examples 1 to 14, wherein the machine learning module is situated in at least one remotely located computing device accessible to the device via a wide area network.

### Example 16

This example includes the elements of any of examples 1 to 15, wherein the device further comprises a sensor module to collect biometric data from the user during the presentation of the content, the user data including at least the biometric data, the machine learning module being further to input the biometric data to the behavioral model to determine the current observed user state.

### Example 17

This example includes the elements of any of examples 1 to 16, wherein the at least one objective is defined in the behavioral model based on a cost function, the at least one objective being to maximize the cost function.

### Example 18

This example includes the elements of example 17, wherein the correspondence comprises associating each observed user state with a value for the cost function and associating content presentation parameter settings for biasing movement between the observed user states.

### Example 19

According to this example there is provided a method. The method may comprise generating a user behavioral model including at least observed user states, determining a correspondence between the observed user states and at least one objective using the behavioral model and content presentation parameters, collecting user data, utilizing the behavioral model to determine a current observed user state based on the user data, utilizing the behavioral model to determine content presentation parameter settings based at least on the current observed user state and causing the content to be presented based on the content presentation parameter settings.

### Example 20

This example includes the elements of example 19, wherein the behavioral model is generated based on user data collected during the presentation of the content with randomized content presentation parameter settings.

### Example 21

This example includes the elements of example 20, wherein the observed user states in the behavioral model are determined based on determining concentrations of values in the user data collected during the presentation of the content with randomized content presentation parameter settings.

### Example 22

This example includes the elements of any of examples 19 to 21, wherein the user data includes biometric data collected from the user during the presentation of the content.

### Example 23

This example includes the elements of example 22, wherein the biometric data is related to at least one of user attention level, user posture, user hand gestures, or sounds generated by the user.

### Example 24

This example includes the elements of any of examples 22 to 23, further comprising inputting the biometric data to the behavioral model to determine the current observed user state.

### Example 25

This example includes the elements of any of examples 19 to 24, wherein the at least one objective is defined in the behavioral model based on a cost function, the at least one objective being to maximize the cost function.

### Example 26

This example includes the elements of example 25, wherein the correspondence comprises associating each observed user state with a value for the cost function.

### Example 27

This example includes the elements of example 26, wherein one of the observed user states is associated with the maximized value of the cost function.

### Example 28

This example includes the elements of example 27, wherein the correspondence further comprises associating content presentation parameter settings for biasing movement between the observed user states.

### Example 29

This example includes the elements of example 28, wherein the biasing is based on percentage probabilities associated with transitioning between each of the observed user states when certain content presentation parameter settings are utilized for content presentation.

### Example 30

This example includes the elements of any of examples 28 to 29, wherein determining content presentation parameter settings comprises selecting the content presentation parameter settings to bias movement of the current observed user state towards an observed user state associated with the maximized cost function.

### Example 31

This example includes the elements of any of examples 18 to 30, wherein causing the content to be presented comprises determining content presentation parameter updates for causing the presentation of the content to be altered based on the content presentation parameter settings.

### Example 32

This example includes the elements of any of examples 18 to 31, wherein the content parameters settings control at least one of content presentation characteristics, content composition or content subject matter.

### Example 33

This example includes the elements of any of examples 18 to 32, wherein the user data includes biometric data collected from the user during the presentation of the content, the method further comprising inputting the biometric data to the behavioral model to determine the current observed user state.

### Example 34

This example includes the elements of any of examples 18 to 33, wherein the at least one objective is defined in the behavioral model based on a cost function, the at least one objective being to maximize the cost function.

### Example 35

This example includes the elements of example 34, wherein the correspondence comprises associating each observed user state with a value for the cost function and associating content presentation parameter settings for biasing movement between the observed user states.

### Example 36

According to this example there is provided a system including at least a device, the system being arranged to perform the method of any of the above examples 19 to 35.

### Example 37

According to this example there is provided a chipset arranged to perform the method of any of the above examples 19 to 35.

### Example 38

According to this example there is provided at least one machine readable medium comprising a plurality of instructions that, in response to be being executed on a computing device, cause the computing device to carry out the method according to any of the above examples 19 to 35.

### Example 39

According to this example there is provided at least one device configured for machine learning-based user behavior characterization, the at least one device being arranged to perform the method of any of the above examples 19 to 35.

### Example 40

According to this example there is provided at least one device having means to perform the method of any of the above examples 19 to 35.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. A system, comprising:
a device including at least a user interface module to present content to a user and to collect data related to the user during the presentation of the content; and
a machine learning module to:
generate a user behavioral model including at least observed user states;
determine a correspondence between the observed user states and at least one objective using the behavioral model and content presentation parameters;
utilize the behavioral model to determine a current observed user state based on the user data; and
utilize the behavioral model to determine content presentation parameter settings based at least on the current observed user state.

27. The system of claim 26, wherein the behavioral model is generated based on user data collected during the presentation of the content with randomized content presentation parameter settings.

28. The system of claim 26, wherein the device further comprises a sensor module to collect biometric data from the user during the presentation of the content, the user data including at least the biometric data.

29. The system of claim 28, wherein the machine learning module is further to input the biometric data to the behavioral model to determine the current observed user state.

30. The system of claim 26, wherein the at least one objective is defined in the behavioral model based on a cost function, the at least one objective being to maximize the cost function.

31. The system of claim 30, wherein the correspondence comprises associating each observed user state with a value for the cost function.

32. The system of claim 31, wherein the correspondence further comprises associating content presentation parameter settings for biasing movement between the observed user states.

33. The system of claim 32, wherein the machine learning module being to determine content presentation parameter settings comprises the machine learning module being to select the content presentation parameter settings to bias movement of the current observed user state towards an observed user state associated with the maximized cost function.

34. The system of claim 26, wherein the device further comprises an application to:
receive the content presentation parameter settings from the machine learning module; and
determine content presentation parameter updates for causing the user interface module to alter the presentation of the content based on the content presentation parameter settings.

35. A method, comprising:
generating a user behavioral model including at least observed user states;
determining a correspondence between the observed user states and at least one objective using the behavioral model and content presentation parameters;
collecting user data;
utilizing the behavioral model to determine a current observed user state based on the user data;
utilizing the behavioral model to determine content presentation parameter settings based at least on the current observed user state; and
causing the content to be presented based on the content presentation parameter settings.

36. The method of claim 35, wherein the behavioral model is generated based on user data collected during the presentation of the content with randomized content presentation parameter settings.

37. The method of claim 35, wherein the user data includes biometric data collected from the user during the presentation of the content, the method further comprising:
inputting the biometric data to the behavioral model to determine the current observed user state.

38. The method of claim 35, wherein the at least one objective is defined in the behavioral model based on a cost function, the at least one objective being to maximize the cost function.

39. The method of claim 38, wherein the correspondence comprises associating each observed user state with a value for the cost function.

40. The method of claim 39, wherein the correspondence further comprises associating content presentation parameter settings for biasing movement between the observed user states.

41. The method of claim 40, wherein determining content presentation parameter settings comprises selecting the content presentation parameter settings to bias movement of the current observed user state towards an observed user state associated with the maximized cost function.

42. The method of claim 35, wherein causing the content to be presented comprises determining content presentation parameter updates for causing the presentation of the content to be altered based on the content presentation parameter settings.

43. At least one machine-readable storage medium having stored thereon, individually or in combination, instructions that when executed by one or more processors result in the following operations comprising:
generating a user behavioral model including at least observed user states;
determining a correspondence between the observed user states and at least one objective using the behavioral model and content presentation parameters;
collecting user data;
utilizing the behavioral model to determine a current observed user state based on the user data;
utilizing the behavioral model to determine content presentation parameter settings based at least on the current observed user state; and
causing the content to be presented based on the content presentation parameter settings.

44. The medium of claim 43, wherein the behavioral model is generated based on user data collected during the presentation of the content with randomized content presentation parameter settings.

45. The medium of claim 43, wherein the user data includes biometric data collected from the user during the presentation of the content, the method further comprising instructions that when executed by one or more processors result in the following operations comprising:
inputting the biometric data to the behavioral model to determine the current observed user state.

46. The medium of claim 43, wherein the at least one objective is defined in the behavioral model based on a cost function, the at least one objective being to maximize the cost function.

47. The medium of claim 46, wherein the correspondence comprises associating each observed user state with a value for the cost function.

48. The medium of claim 46, wherein the correspondence further comprises associating content presentation parameter settings for biasing movement between the observed user states.

49. The medium of claim 48, wherein determining content presentation parameter settings comprises selecting the content presentation parameter settings to bias movement of the current observed user state towards an observed user state associated with the maximized cost function.

50. The medium of claim 43, wherein causing the content to be presented comprises determining content presentation parameter updates for causing the presentation of the content to be altered based on the content presentation parameter settings.
